(19) United States
(12) Patent Application Publication
(10) Pub. No.: US 2006/0120089 A1
(43) Pub. Date: Jun. 8, 2006

(54) Light string mounting system

(76) Inventor: Venturino L. Liberatore, Willmette, IL (US)

Correspondence Address: BARNES & THORNBURG, LLP, P.O. BOX 2786, CHICAGO, IL, 60690-2786, US

(21) Appl. No.: 11/005,114

(22) Filed: Dec. 6, 2004

(51) Int. Cl. F21V 21/08

(52) U.S. Cl. 362/391; 362/389; 362/396; 362/806; 362/807

(57) ABSTRACT

A mounting apparatus and system for mounting decorative light strings using hook and loop fasteners to enable decorative light strings to be mounted to a surface or structure in an easily removable manner. The mounting apparatus is comprised of a fixed member having a mounting aid for locating said fixed member in place and a suspension member, wherein the suspension member is shaped to be disposed about an electrical conductor with portions of the suspension member joined together forming a channel for sliding along the electrical conductor. The suspension member is joined to the fixed member by the cooperation of a first portion of a hook and loop fastener on the suspension member and a second portion of a hook and loop fastener on the fixed member. A plurality of spaced mounting apparatuses provide a mounting system for a string of lights.

### FIELD OF INVENTION

The invention generally relates to a system for flexibly mounting a string of decorative electrical lights.

### BACKGROUND OF INVENTION

Strings of electrical lights have long been used as decorations for holidays and other festive occasions. The light strings consist of a number of sockets into which miniature light bulbs are inserted, connected to a length of insulated electrical wire with a plug for connection into a standard electrical outlet. Light strings, commonly referred to as “rope lights,” may also have a clear, colored, or translucent flexible sheath, such as flexible polyvinylchloride (PVC) tubing enclosing the bulbs, sockets and electrical conductors.

Such light strings were traditionally displayed around the Christmas holiday season mounted on houses and other structures, typically along the eaves, rooflines, and windows. Recently, the popularity of displaying decorative lights has increased to where light strings are used for decoration on occasions other than the Christmas holiday season, such as Halloween and Valentines Day. Frequently, decorative lights for the various occasions differ in color. For example, white or multicolored lights for Christmas, red or pink for Valentines Day, and orange for Halloween. This requires the light string for one occasion to be taken down and replaced with light strings of different colors for other occasions.

In addition to residential holiday decoration, decorative light strings are used to provide a festive atmosphere for commercial establishments such as bars, restaurants, and retail shops. Decorative light strings can be used in commercial setting during select holiday seasons or year around. The embodiments of the present invention provide an easily removable flexible means of mounting light strings that is adaptable to changing holidays, such as from Christmas to Valentines Day, and adaptable to various structural configurations.

With each occasion that decorative light strings are displayed, they must be put up and taken down. Traditional methods of mounting decorative light strings included nails, screws, hooks, clips, staples, tape, and other means. These traditional methods were time consuming in mounting and removing the light strings. Additionally, a number of the mounting methods such as nails, screws, hooks, clips and staples required care so as not to puncture the electrical insulation on the wire which had the potential of leading to a short circuit, notwithstanding the holes made in the supporting structure.

More modern methods of mounting light strings employing hook and loop fastener systems are known in the art. Hook and loop fasteners are well known under the trademark VELCRO® registered to Velcro USA, Inc. Hook and loop fasteners comprise a “hook” tape and a “loop” tape, which, when pressed together, have hooks that catch on loops causing the two parts to remain together until pulled apart.

For example, U.S. Pat. No. 4,244,014 discloses two strips of hook and loop fastener mounted on a structure. The sockets of the light string are placed between the strips and the strips pressed together to hold the socket in place.

In another example, U.S. Pat. No. 5,142,461 discloses one portion of a hook and loop fastener portion attached to a surface of a structure. The mating portion of the hook and loop fastener is affixed about the socket by means of an adhesive. The socket is then pressed against the fastener portion attached to the structure to mount the light string.

In yet another example, U.S. Pat. No. 5,518,214 discloses two hook and loop fastener portions. The first portion is attached to a surface by means of an adhesive, the second portion is attached to a light string by a fastener passing through two holes in the second portion and tied about the electrical wire of the light string. The light string is mounted to the structure by pressing the first and second portions of the hook and loop fastener together.

In yet another example, U.S. Patent Application Publication No. US 2002/0039290 discloses one portion of a hook and loop fastener system attached by adhesive to a light emitting diode (LED) socket and a second portion of a hook and loop fastener system attached by adhesive to sheet of flexible material, creating what is commonly known as a “starcloth.”

### SUMMARY OF INVENTION

The present invention is directed to providing a simple and flexible system for mounting decorative light strings using hook and loop fasteners. The present invention allows decorative light strings to be mounted to a structure in an easily removable manner by use of hook and loop fasteners. One portion of the fastener, the fixed portion, is attached to a structure or surface and the other portion of the fastener, the suspension portion, is positioned about an electrical conductor of a string of lights such that the suspension portion is easily movable along a length of the wire to provide flexibility in locating the fasteners for mounting.

The present invention is directed to a mounting apparatus comprising a fixed member having a front surface and a rear surface, with a mounting aid for locating said fixed member in place and a suspension member having an inside surface, an outside surface, a first end, and a second end. The suspension member is shaped to be disposed about an electrical conductor with portions of the suspension member joined together forming a channel for sliding along the electrical conductor and is joined to the fixed member by the cooperation of a first portion of a hook and loop fastener on the suspension member and a second portion of a hook and loop fastener on the fixed member. The electrical conductor includes a plurality of sockets with light bulbs mounted therein.

The present invention is also directed towards a mounting system comprising a plurality of mounting apparatuses spaced at intervals about the electrical conductor. The mounting apparatuses can be positioned so that the light string is draped to achieve a desired appearance The mounting system can also comprise a storage bundler having a first and second axial member and a first and second lateral member. The lateral members are joined to the axial members proximate to the ends. A handle is joined to one of the axial members, allowing the storage bundler to be held while the electrical conductor is wound around the first and second lateral members between the first and second axial members.

### BRIEF DESCRIPTION OF DRAWINGS

The foregoing and other aspects of the invention will become more apparent from the following description of specific embodiments thereof and the accompanying drawings which illustrate, by way of example only and not intending to be limiting, the principles of the invention. In the drawings:

FIG. 1 illustrates one mounting apparatus embodiment of the present invention wherein the ends of the suspension member are brought together;

FIG. 2 illustrates another mounting apparatus embodiment of the invention wherein the ends of the suspension member are lapped over each other to form a cylindrical tube;

FIG. 3 illustrates a mounting system having a plurality of mounting apparatuses for mounting a string of decorative lights; and

FIG. 4 illustrates a string of decorative lights with a plurality of mounting apparatuses on a storage bundler.

### DETAILED DESCRIPTION OF ILLUSTRATIVE EMBODIMENTS

In one embodiment of the present invention, one portion of a hook and loop fastener, the fixed member 12, is formed to be attached to a surface or a structure. FIG. 1 depicts a single mounting apparatus 10 of the present invention. As shown in FIG. 1, the fixed member 12 of the mounting apparatus, comprised of a piece of loop fastener, is formed to be attached to a surface or structure (not shown) by means of an adhesive on the rear side 14 of fixed member 12 such that the front side 16 with a plurality of loops 18 is facing away from the surface or structure. Other means of fastening, such as screws, nails, staples, and the like can be used instead of or in addition to adhesive.

A suspension member 20, comprised of strip of hook fastener, having a first end 22 and a second end 24, is positioned about a wire 40 for a string of lights and formed to bring ends 22 and 24 together to form an inside surface 26, and an outside surface 28 having a plurality of hooks 30. Once the ends 22, 24 of the suspension member 20 are brought together, an open channel 32, much larger in cross section than the wire 40, is formed through which the wire 40 for the light string readily passes, creating the suspension portion 20 and positioning it about the wire 40.

In the embodiment depicted in FIG. 1, the back side of the strip ends 22, 24 are brought together and fastened. FIG. 1 depicts a fastener consisting of a staple 34, however it is understood that other fastening means may be used such as stitching, adhesives, rivets, clips, and the like.

In another embodiment depicted in FIG. 2, the ends 122, 124 of the suspension member 120 are positioned with the ends overlapping such that the front side of the first 122 end is in contact with the rear side of the second end 124. The overlapping ends may then be fastened together by means such as staples, adhesives, rivet, clips, and the like. The embodiment of FIG. 2 depicts a cylindrical tube having a channel 132 through which the wire 40 for the light string readily passes.

It should be understood, that while the embodiments of the invention depicted in FIG. 1 and FIG. 2 have hook fastener as the suspension member and loop fastener as the fixed member, it should be obvious to one skilled in the art that the opposite arrangement is equally acceptable. Also, other types of fastener systems can be used so long as the suspension member and the fixed member can be repeatedly separated and re-fastened.

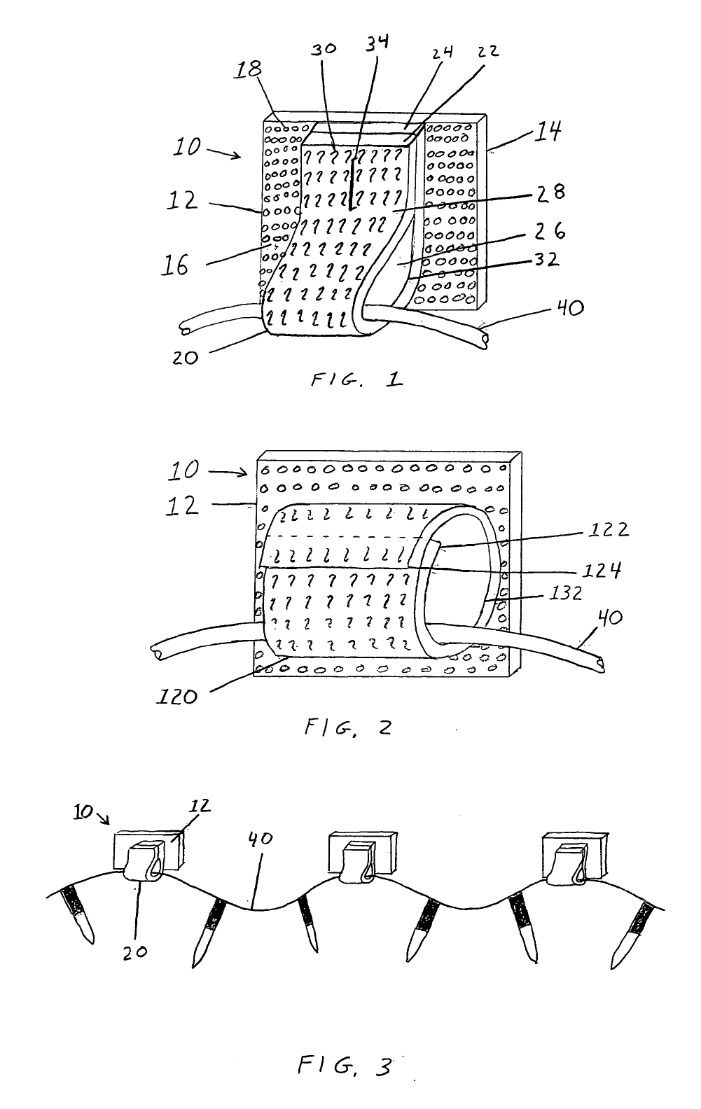

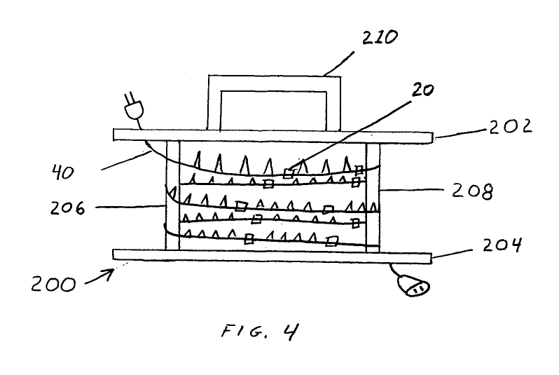

FIG. 3 depicts a representation of the present invention for mounting a string of lights. The user first attaches the fixed members 12 of the mounting apparatus 10 to a surface or a structure at desired spaced locations. This is accomplished by removing a backing layer to expose adhesive on the rear side 14 of the fixed member. The fixed member is then pressed onto the surface or structure, being held in place by the adhesive. The user attaches a suspension member 20 to a fixed member 12 by pressing the two together causing the hooks to cooperate with the loops of the hook and loop fastener completing the mounting apparatus.

Light strings vary in length and number of lights. Longer light strings will require more mounting apparatuses than shorter strings. A mounting apparatus of the present invention should be positioned along the light string at a sufficient interval to allow the desired draping of the light string.

However, the number of mounting apparatuses may be varied depending on the appearance of the lights desired by the user. For example, more mounting apparatuses may be used at smaller intervals may be used to provide an crisp, straight line appearance to the light string. Meanwhile, fewer mounting apparatuses may be used at greater intervals to create a wavy, undulating appearance. Finally, as should be apparent, the mounting apparatuses of the present invention may be placed at irregular intervals for the user to create almost any appearance or to fit almost any structural arrangement.

Once the user has attached a plurality of fixed members at various desired locations, set-up and take-down of light strings is a simple, quick, and efficient process. For set-up, the user need only press the suspension members disposed about the light string against the fixed members to set-up the light string. To take down the string, the user need only pull the suspension members away from the fixed portions. The user does not have to bother with nails, staples, screws, hooks, clips, tape, or other cumbersome means currently employed to mount light strings.

Furthermore, the process of installing and removing light strings can be additionally simplified by incorporating a storage bundler into the system of the present invention. The storage bundler 200 is comprised of a pair of axial frame members 202, 204, a pair of lateral frame members 206, 208 connecting the axial frame members at opposite ends, and a handle 210. The light string 40 with a plurality of suspension members 20 positioned at various locations along the string is wound around the lateral frame members 206, 208 between the axial frame members 202, 204. The user holds the storage bundler while unwinding the light string and pressing the suspension members against the fixed members, providing a quick and simple way to hang a light string. In taking down the light string, the user simply pulls the suspension members from the fixed members and winds the light string onto the storage bundler. This provides for easy storage and reduces tangling of the light string.

An additional benefit of the present invention is that by positioning the suspension member 20 about the wire 40 itself, a relatively large surface area, compared to the surface area of the wire itself, supports the wire. The wire 40 also is free for limited movement such as swaying in the breeze when used in outdoor applications. The large supporting surface and limited range of movement reduces the possibility of mechanical stress concentrations in the electrical insulation that could arise from other fastening methods such as nails, screws, staples, ties and the like. Such fastening methods contact the wire with a relatively small surface area relative to that of the wire and can lead to cracking, abrading, and other damage to the electrical insulation on the wire which could in turn cause a short-circuit.

Various changes may be made to the invention without departing from the spirit thereof or scope of the following claims.

I claim:

1. A mounting apparatus comprising:
a fixed member having a front surface and a rear surface, said fixed member having a mounting aid for locating said fixed member in place;
a suspension member having an inside surface, an outside surface, a first end, and a second end, wherein said suspension member is shaped to be disposed about an electrical conductor with portions of said suspension member joined together forming an open channel for sliding along the electrical conductor; and
said suspension member being joined to said fixed member by the cooperation of a first portion of a hook and loop fastener on said suspension member and a second portion of a hook and loop fastener on said fixed member.

2. The mounting apparatus of claim 1 wherein said electrical conductor includes a plurality of sockets.

3. The mounting apparatus of claim 2 wherein a plurality of light bulbs are mounted in said plurality of sockets.

4. The mounting apparatus of claim 1 wherein said mounting aid is an adhesive disposed on said rear surface of said fixed member.

5. A mounting system comprising:
a plurality of mounting apparatuses as claimed in claim 1.

6. The mounting system of claim 5 wherein said mounting aid is an adhesive disposed on said rear surface of each fixed member.

7. A mounting system of claim 5 wherein said electrical conductor includes a plurality of sockets.

8. A mounting system of claim 7 wherein a plurality of light bulbs are mounted in said plurality of sockets.

9. A mounting system of claim 5 further comprising:
a storage bundler comprised of
a first axial member;
a second axial member;
a first lateral member;
a second lateral member;
wherein said first lateral member is joined to said first and said second axial members proximate to each first end,
wherein said second lateral member is joined to said first and said second axial members proximate to each second end,
wherein said electrical conductor having a plurality of said suspension members disposed about it is wound around said first lateral member and said second lateral member between said first axial member and said second axial member; and
a handle joined to one of said axial members.

10. A mounting system of claim 9 wherein said electrical conductor includes a plurality of sockets.

11. A mounting system of claim 10 wherein a plurality of light bulbs are mounted in said plurality of sockets.

12. A light string comprising:
at least one insulated electrical conductor having a plug;
a plurality of spaced sockets connected to said electrical conductor forming conductor sections along said electrical conductor;
a plurality of light bulbs mounted in said plurality of sockets;
a plurality of suspension members spaced along said electrical conductor, each said suspension member having an inside surface, an outside surface, a first end, and a second end, wherein said suspension member is shaped to be disposed about said electrical conductor with portions of said suspension member joined together forming an open channel for sliding along the electrical conductor;
a plurality of fixed members having a front surface and a rear surface, each said fixed member having a mounting aid for locating said fixed member in place; and
a joining of said suspension members to said fixed members to mount the light string in place.

13. The light string of claim 12 wherein said mounting aid is an adhesive disposed on said rear surface of said fixed member.

14. The light string of claim 12 wherein said joining comprises cooperating portions of hook and loop fastener of said suspension members and said fixed members.
